(19) United States
(12) Patent Application Publication
(10) Pub. No.: US 2024/0308303 A1
(43) Pub. Date: Sep. 19, 2024

(54) ELECTRONIC DEVICE

(71) Applicant: InnoLux Corporation, Miao-Li County (TW)

(72) Inventors: Cheng-Yi CHEN, Miao-Li County (TW); Chi-Chau LIN, Miao-Li County (TW)

(21) Appl. No.: 18/442,907

(22) Filed: Feb. 15, 2024

(30) Foreign Application Priority Data
Mar. 15, 2023 (CN) 202310247524.X

(51) Int. Cl. B60J 3/02; B60J 3/04; B60R 11/00; B60R 11/02; G02F 1/13; G06V 20/59; H05B 45/10

(52) U.S. Cl. CPC B60J 3/0204; B60J 3/04; B60R 11/0235; G02F 1/1313; G06V 20/59; H05B 45/10; B60R 2011/0035

(57) ABSTRACT

An electronic device includes a dimming structure, a control unit, a plurality of sensors and an angle sensor. The control unit is electrically connected to the dimming structure. The plurality of sensors are electrically connected to the control unit, and output a sensing result based on a plurality of sensing values sensed by the sensors. The angle sensor is electrically connected to the control unit, and senses a rotation angle of the dimming structure. Based on the sensing result and the rotation angle, the control unit outputs a voltage to the dimming structure.

### CROSS-REFERENCE TO RELATED APPLICATIONS

This application claims the benefits of the Chinese Patent Application Serial Number 202310247524.X, filed on Mar. 15, 2023, the subject matter of which is incorporated herein by reference.

### BACKGROUND

### Field of the Disclosure

The present disclosure relates to an electronic device and, more specifically, the present disclosure relates to an electronic device that blocks ambient light.

### Description of Related Art

In general, although car sun visors can block ambient light in use, they also block the driver's sight, causing trouble while driving and even causing dangerous situations such as car accidents.

With the development of science and technology, liquid crystal (LC) devices are used as automobile sun visors. The LCD sun visor can be controlled such that a part of its area is in a dark state so as to block the ambient light from passing through. For example, it can block the sunlight from passing through the dark area, while the remaining area is kept to be transparent so as to avoid blocking the driver's sight, thereby avoiding car accidents. However, when using such an LCD sun visor to block the sunlight, the position of the sun and the position of the human eyes have to be known to correctly control the changes in dark and transparent states of the LCD sun visor, which requires extremely complicated artificial intelligence (AI) calculations that are beyond the capability of the ordinary automotive computer. Moreover, when the sunlight changes drastically, it is more likely to cause the failure of the LCD visor control, which is thus not so satisfactory.

Therefore, it is desired to provide an improved electronic device to solve the aforementioned problems.

### SUMMARY

The present disclosure provides an electronic device, which includes: a dimming structure; a control unit electrically connected to the dimming structure; a plurality of sensors electrically connected to the control unit to output a sensing result based on sensing values sensed by the plurality of sensors; and an angle sensor electrically connected to the control unit to sense a rotation angle of the dimming structure, wherein the control unit outputs a voltage to the dimming structure based on the sensing result and the rotation angle.

Other novel features of the disclosure will become more apparent from the following detailed description when taken in conjunction with the accompanying drawings.

### BRIEF DESCRIPTION OF DRAWINGS

FIG. 1 is a schematic diagram of an electronic device and its usage status according to an embodiment of the present disclosure;

FIG. 2 is a schematic side view of the electronic device of FIG. 1;

FIG. 3 is a schematic diagram illustrating the arrangement of sensors according to an embodiment of the present disclosure;

FIG. 4 is a schematic diagram illustrating the arrangement of sensors according to another embodiment of the present disclosure;

FIG. 5A is a schematic diagram of an implementation according to the electronic device of the present disclosure;

FIG. 5B is a schematic diagram of another implementation according to the electronic device of the present disclosure;

FIG. 5C is a schematic diagram of still another implementation according to the electronic device of the present disclosure;

FIG. 5D is a schematic diagram of yet another implementation according to the electronic device of the present disclosure;

FIG. 6 shows a mathematical model of the electronic device for controlling the dimming structure according to an embodiment of the present disclosure;

FIG. 7 is another schematic side view of an electronic device according to an embodiment of the present disclosure;

FIG. 8 is a schematic diagram of an electronic device according to another embodiment of the present disclosure;

FIG. 9 is a schematic diagram illustrating the arrangement of sensors according to of still another embodiment of the present disclosure; and

FIG. 10 is a schematic diagram of an electronic device according to still another embodiment of the present disclosure.

### DETAILED DESCRIPTION OF EMBODIMENT

Different embodiments of the present disclosure are provided in the following description. These embodiments are meant to explain the technical content of the present disclosure, but not meant to limit the scope of the present disclosure. A feature described in an embodiment may be applied to other embodiments by suitable modification, substitution, combination, or separation.

It should be noted that, in the present specification, when a component is described to “comprise”, “have”, “include” an element, it means that the component may include one or more of the elements, and the component may include other elements at the same time, and it does not mean that the component has only one of the element, except otherwise specified.

Moreover, in the present specification, the ordinal numbers, such as “first” or “second”, are only used to distinguish a plurality of elements having the same name, and it does not means that there is essentially a level, a rank, an executing order, or an manufacturing order among the elements, except otherwise specified. The ordinal numbers of the elements in the specification may not be the same in claims. For example, a “second” element in the specification may be a “first” element in the claims.

In the present specification, except otherwise specified, the feature A “or” or “and/or” the feature B means only the existence of the feature A, only the existence of the feature B, or the existence of both the features A and B. The feature A “and” the feature B means the existence of both the features A and B.

Moreover, in the present specification, the terms, such as “top”, “upper”, “bottom”, “front”, “back”, or “middle”, as well as the terms, such as “on”, “above”, “over”, “under”, “below”, or “between”, are used to describe the relative positions among a plurality of elements, and the described relative positions may be interpreted to include their translation, rotation, or reflection.

Furthermore, the terms recited in the specification and the claims such as “above”, “over”, “on”, “below”, or “under” are intended that an element may not only directly contacts other element, but also indirectly contact the other element.

Furthermore, the term recited in the specification and the claims such as “connect” is intended that an element may not only directly connect to other element, but also indirectly connect to other element. On the other hand, the terms recited in the specification and the claims such as “electrically connect” and “couple” are intended that an element may not only directly electrically connect to other element, but also indirectly electrically connect to other element.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those skilled in the art, the background of the present disclosure or the context of the present specification, and should not be read by an ideal or over-formal way.

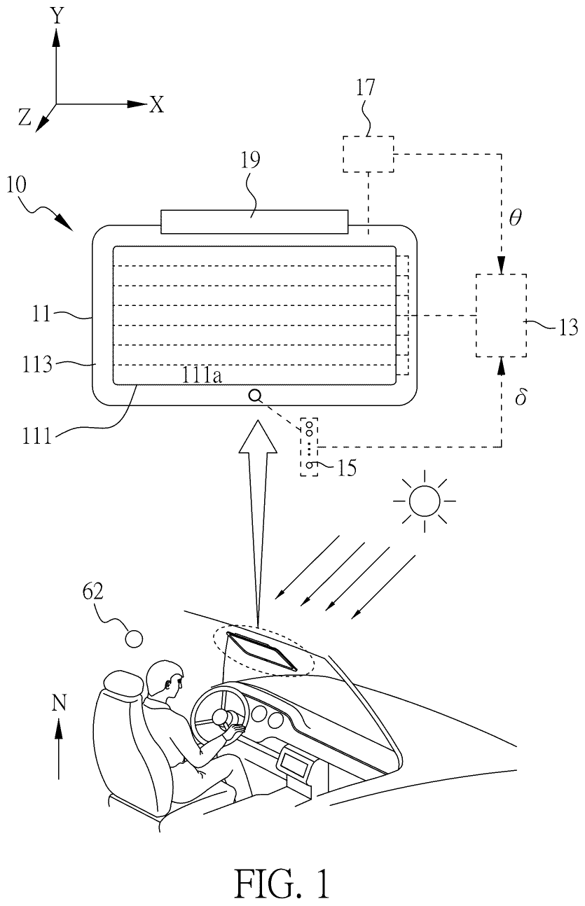

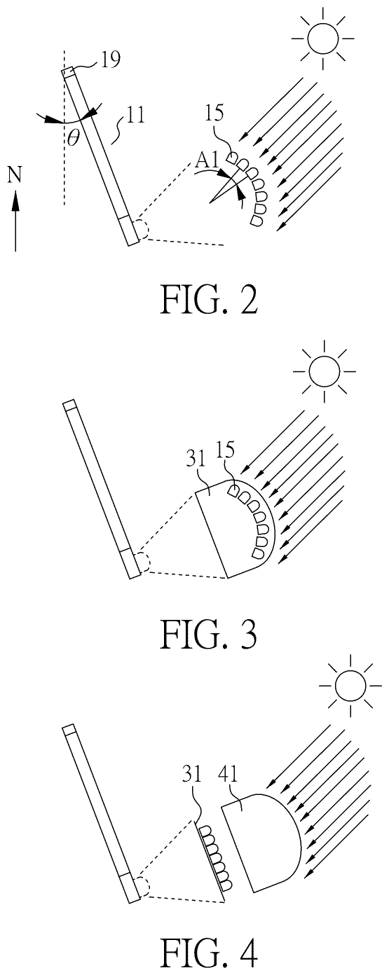

FIG. 1 is a schematic diagram of an electronic device and its usage state according to an embodiment of the present disclosure. FIG. 2 is a side view of the electronic device of FIG. 1. The electronic device 10 includes a dimming structure 11, a control unit 13, a plurality of sensors 15 and an angle sensor 17. The control unit 13 is electrically connected to the dimming structure 11. The plurality of sensors 15 are electrically connected to the control unit 13 for sensing a plurality of sensing values, and output a sensing result to the control unit 13 based on the plurality of sensing values. The angle sensor 17 is electrically connected to the control unit 13 for sensing a rotation angle (θ) of the dimming structure 11. The control unit 13 may output a voltage to the dimming structure 11 based on the sensing result and the rotation angle (θ) so as to control the state of the dimming structure 11. The light transmittance of the dimming structure 11 may be adjusted by voltage, so that the effect of blocking ambient light, such as blocking sunlight, can be achieved, wherein the dimming structure 11 may, for example, include a liquid crystal structure 111, and the liquid crystal structure 111 includes an upper substrate, a lower substrate and a liquid crystal layer. The liquid crystal type of the liquid crystal layer may be, for example, PDLC (polymer dispersed liquid crystal), PSCT (polymer stabilized cholesteric texture), PNLC (polymer network liquid crystal), CLC (cholesteric liquid crystal), etc., while this is only an example but not a limitation. The control unit 13 may be, for example, an integrated circuit (IC), a micro integrated circuit (Micro IC) or a thin film transistor. In addition, the control unit 13 may also be, for example, a central control system or a control system of a local device of the car, etc., but it is not limited thereto. The sensing result may include, for example, the light sensing values of the plurality of sensors 15, and the control unit 13 may determine the incident angle of the ambient light based on the sensing result, while the determination process will be described in the following.

As shown in FIG. 1, the electronic device 10 may be installed inside a car for use as a sun visor. Therefore, the dimming structure 11 of the electronic device 10 may be of any shape. In one embodiment, it may be rectangle, rhombus, circle, square, etc., while it is not limited thereto. The dimming structure 11 includes a liquid crystal structure 111 and a frame body 113 surrounding the liquid crystal structure 111. The liquid crystal structure 111 may be divided into a plurality of sub-areas 111a in the X direction of the dimming structure 11, which are respectively electrically connected to the control unit 13. Please refer to FIG. 1. For convenience of explanation, the liquid crystal structure 111 in FIG. 1 is divided into seven sub-areas 111a, while this is only an example but not a limitation. Furthermore, the dimming structure 11 of the electronic device 10 may be rotatably installed to a car through a rotating shaft structure 19. The rotating shaft structure 19 may be, for example, a mechanical gear structure or an electronic gear structure, but it is not limited thereto. Therefore, the dimming structure 11 may have a rotation angle (θ) relative to the normal direction N of the ground (that is, the direction perpendicular to the ground or the bottom of the car body), as shown in FIG. 2. The control unit 13, the plurality of sensors 15 and the angle sensor 17 may, for example, be disposed on the frame body 113 of the dimming structure 11, wherein the angle sensor 17 may be disposed on the frame body 113 and close to the rotating shaft structure 19 to facilitate the detection of the rotation angle (θ) of the dimming structure 11. For example, the angle sensor 17 may be electrically connected to the rotating shaft structure 19 to receive the rotation signal of the rotating shaft structure 19 thereby determining the rotation angle (θ) of the dimming structure 11, while this is only an example but not a limitation.

In this embodiment, the sensors 15 are light sensors, and the sensing values are light sensing values. The light sensors may be, for example, charge-coupled devices (CCDs), infrared sensors, ultraviolet sensors, cameras, etc., but the present disclosure is not limited thereto. As shown in FIG. 1 and FIG. 2, the plurality of sensors 15 may be disposed on the frame body 113, and the plurality of sensors 15 may be arranged in an arc shape, so that two sensors 15 that are adjacent to each other are separated by a central angle A1, that is, are disposed at a central angle A1. The central angle A1 is defined by the following: first obtaining the arc-shaped outline formed by the arrangement of the plurality of sensors 15; determining the center of a circle corresponding to the arc-shaped outline; and constituting a central angle by the two adjacent sensors 15 and the center of the circle, which is the central angle A1, wherein the central angle A1 may be, for example, 1 to 10 degrees, 10 to 15 degrees, 15 to 20 degrees, 20 to 25 degrees, 25 to 30 degrees, 30 to 35 degrees, 35 to 40 degrees, 40 to 45 degrees, etc., but it is not limited thereto. In this embodiment, the dimming structure 11 is a rectangle, and the plurality of sensors 15 may be disposed on a long side of the frame body 113 away from the rotating shaft structure 19 and arranged in an arc shape along the short side of the dimming structure 1. For convenience of description, the electronic device 10 is shown to have seven sensors 15 in the figures, while this is only an example but not a limitation.

Furthermore, as shown in FIG. 3, which is a schematic diagram illustrating the arrangement of sensors of the electronic device according to an embodiment of the present disclosure. The plurality of sensors 15 may be disposed on a substrate 31 on the frame body 113. The substrate 31 may be, for example, a flexible printed circuit (FPC), a printed circuit board (PCB), etc., but it is not limited thereto. In one embodiment, the substrate 31 has an arc surface, so that the plurality of sensors 15 may be arranged on the arc surface of the substrate 31 and thus two adjacent sensors 15 are separated by a central angle A1. Alternatively, as in FIG. 4, which is a schematic diagram illustrating the arrangement of sensors of the electronic device according to another embodiment of the present disclosure. In this embodiment, the substrate 31 has a plane, and the plurality of sensors 15 may be linearly arranged on the plane of the substrate 31, which is arranged on the frame body 113, while a lens 41 is arranged on the plurality of sensors 15. The lens 41 may, for example, directly contact the plurality of sensors 15, or there may be a distance or other laminations, such as optical film layers, air media, etc., between the lens and the plurality of sensors. Through the focusing effect of the lens 41, the arrangement of the plurality of sensors 15 and the lens 14 is equivalent to an arrangement of two adjacent sensors 15 at a central angle A1. The lens 41 may be, for example, a concave lens, such as a biconcave lens, a plano-concave lens or a convex-concave lens, a convex lens, such as a biconvex lens, a plano-convex lens or a concave-convex lens, but it is not limited thereto.

In the following embodiments, an electronic device to block sunlight is used as an example. However, in addition to blocking of sunlight, the present invention may also block ambient light according to the circumstances, which is hereby clarified. With the aforementioned arrangement of the plurality of sensors 15 and the rotation angle of the dimming structure 11, the information about the incident sunlight may be sensed and the incident angle of the sunlight may be calculated. The principle of the sensing calculation is explained below and, for a clear explanation, the definition of each expression is clearly described as follows. The number of sensors 15 of the electronic device is N, and the sensors 15 are numbered and arranged sequentially so that S(N) represents each numbered sensor 15. For example, in one embodiment, if N=7, the number of sensors is 7, and the numbers are from 1 to 7, where the number-1 and the number-7 are the sensors 15 respectively arranged at the head and tail, and the number-4 is the sensor 15 arranged in the middle, so that number-4 will be disposed in the normal direction Z of the dimming structure 11. The dimming structure 11 may have a rotation angle (θ), which is the included angle between the extension direction of the dimming structure 11 and the normal direction N of the ground. The solar zenith angle (q) is defined as the included angle between the incident direction of sunlight and the normal direction of the ground. The incident angle of sunlight is defined as the included angle between the incident direction of sunlight and the horizontal direction of the ground. Therefore, the difference between the incident angle of sunlight and the solar zenith angle is 90 degrees.

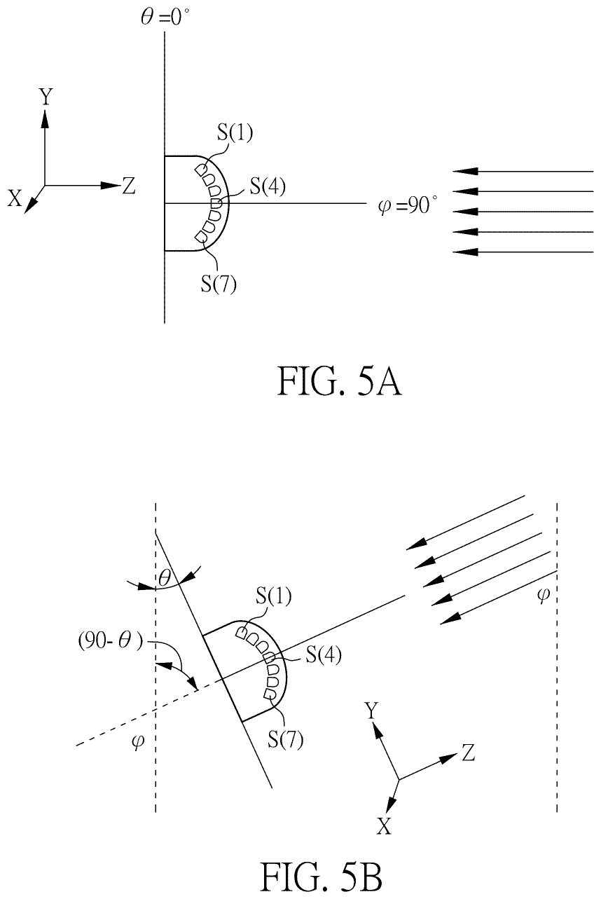

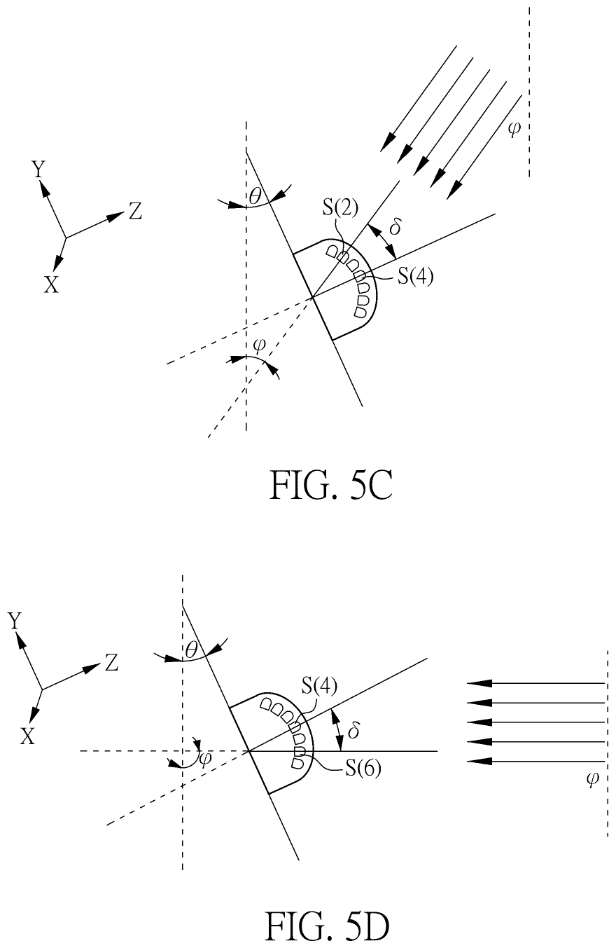

FIG. 5A is a schematic diagram of an implementation according to the electronic device of the present disclosure, in which the electronic device has seven sensors 15. In FIG. 5A, each sensor 15 is represented as S(N), where N=1˜7. The dimming structure 11 has a rotation angle (θ), which is 0 degrees. At this time, if the solar zenith angle (φ) is 90 degrees (that is, the incident angle of sunlight is 0 degrees), the incident direction of the sunlight is the normal direction of the dimming structure 11, and thus the sensor S(4) in the middle has the maximum sensing value. Therefore, when the rotation angle (θ) of the dimming structure 11 is 0 degrees and the sensor S(4) has the maximum sensing value, it may be inferred that the solar zenith angle is 90 degrees.

FIG. 5B is a schematic diagram of another implementation according to the electronic device of the present disclosure, in which the dimming structure 11 has a rotation angle (θ), the sensor S(4) has a maximum sensing value, and the included angle between the direction of the sunlight incident on the sensor S(4) and the normal direction N of the ground is (90−θ) degrees, which is the same as the solar zenith angle (φ), that is, φ=(90−θ). Moreover, the difference between the incident angle of sunlight and the solar zenith angle is 90 degrees, and thus it may be inferred that the incident angle of sunlight is equal to (90−φ)=0.

FIG. 5C is a schematic diagram of still another implementation according to the electronic device of the present disclosure, in which the dimming structure 11 has a rotation angle (θ), and sunlight is mainly incident on the sensor S(N), where N<4, for example, the sensor S(2) has the maximum sensing value. The solar zenith angle is equal to φ, the included angle between the direction of the sunlight incident on the sensor S(2) and the normal direction Z of the ground is also φ, and the included angle between the direction of the sunlight incident on the sensor S(2) and the normal direction Z of the dimming structure 11 (in this embodiment, that is, between the sensor S(2) and the sensor S(4) in the middle) is equal to 8. Since φ+δ+θ+90=180 degrees, it may be deduced that φ=(90−δ−θ). Therefore, it can be seen that the incident angle of sunlight is (90−φ)−(θ+δ).

FIG. 5D is a schematic diagram of yet another implementation according to the electronic device of the present disclosure, in which the dimming structure 11 has a rotation angle (θ), and sunlight is mainly incident on the sensor S(N), where N>4, for example sensor S(6) has the maximum sensing value. The solar zenith angle is φ, the included angle between the direction of sunlight incident on sensor S(6) and the normal direction Z of the ground is also equal to φ, and the included angle between the direction of the sunlight incident on the sensor S(6) and the normal direction Z of the dimming structure 11 (in this embodiment, that is, between the sensor S(6) and the sensor S(4) in the middle) is 8. Accordingly, it can be seen that φ=θ+(90−δ), and the incident angle of sunlight is (90−φ)=(δ−θ).

According to the above model calculation, it can be seen that the incident angle of sunlight is (θ±δ), in which, when N<4, δ is a positive value (that is, the incident angle of sunlight is (θ+|δ|)), when N>4, δ is a negative value (that is, the incident angle of sunlight is (θ−|δ|)) and, when N=4, δ is 0. In order to obtain calculation results quickly, a lookup table may be established in the electronic device 10 to quickly find δ so as to greatly reduce the amount of calculation. As shown in Table 1 below, the lookup table is established by using a design of nine sensors. With the lookup table, it is able to find δ quickly. In addition, in most cases, sunlight is not directly incident on the sensors 15. Therefore, in the calculation process, two sensors 15 with the relatively large sensing values may be selected for calculation with the interpolation method to find the correct angle.

TABLE 1

| δ1 | δ2 | δ3 | δ4 | δ5 | δ6 | δ7 | δ8 | δ9 |
|---|---|---|---|---|---|---|---|---|
| 90 | 67.5 | 45 | 22.5 | 0 | −22.5 | −45 | −67.5 | −90 |

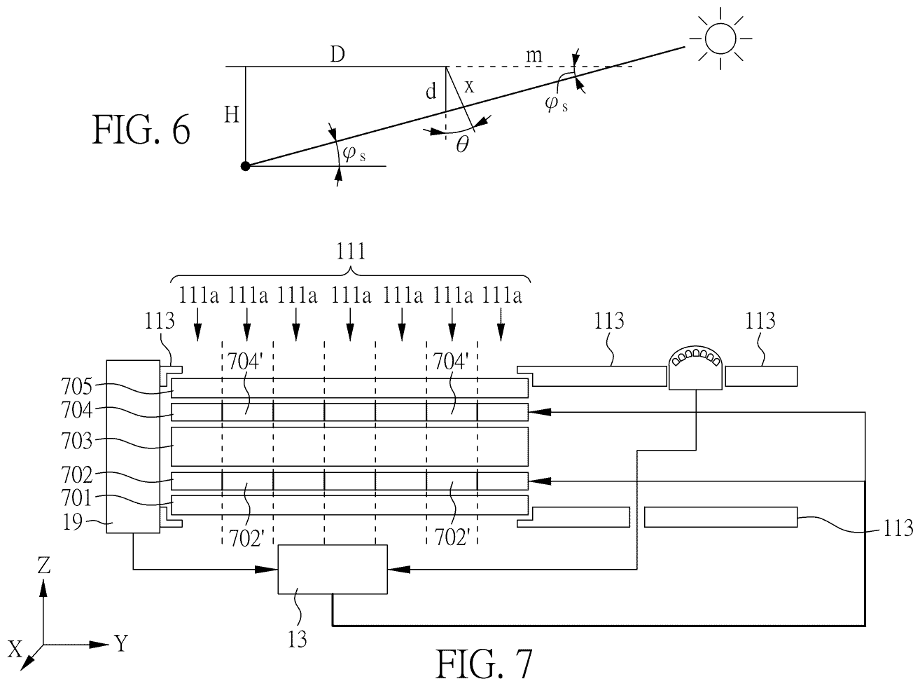

After calculating the incident angle of sunlight, the electronic device 10 may control the liquid crystal structure 111 of the dimming structure 11 according to the incident angle of sunlight and the eyes position of the driver or passenger, so that the control unit 13 outputs voltage to the dimming structure 11 to convert at least one sub-area 111a into a dark state thereby achieving a sunshade effect. FIG. 6 shows a mathematical model used to control the dimming structure 11, wherein φₛ represents the incident angle of sunlight (=(90−φ)), H represents the distance from the eyes of the driver or passenger to the car roof, D represents the distance from the driver or passenger to the sun visor (dimming structure 11), θ represents the rotation angle of the sun visor (dimming structure 11), d and m are variables, x is a numerical value representing which sub-area or sub-areas 111a need to be converted into a dark state. The model in FIG. 6 includes the following operation process:

$$( D + m ) = H cot {φ}_{s} … \qquad ( 1 )$$

$$m = d cot {φ}_{s} … \qquad ( 2 )$$

With equation (1)-equation (2), it can be obtained that D=(H−d) cot φₛ

$$d = H - D tan {φ}_{s} \qquad ( 3 )$$

$$and$$

$$d = x sec θ$$

$$x = ( H - D tan {φ}_{s} ) cos θ …$$

From the result of equation (3), it can be known which sub-area or sub-areas 111a need to be converted into the dark state. In addition, since the aforementioned calculation requires information such as the distance (H) from the eyes of the driver or passenger to the car roof and the distance (D) from the driver or passenger to the sun visor (D), as shown in FIG. 1, the electronic device 10 may further include a detector 62 for detecting the distance (H) between the eyes of the driver or passenger and the car roof, the distance (D) between the driver or passenger and the sun visor, or both. Alternatively, without using the detector 62, the height of the driver or passenger may be used to estimate the distance (H) between the eyes of the driver or passenger and the car roof, the distance (D) between the driver or passenger and the sun visor, or both. The detector 62 may be, for example, a laser rangefinder, an infrared rangefinder, etc., while any instrument capable of measuring distance can be used to implement the detector 62.

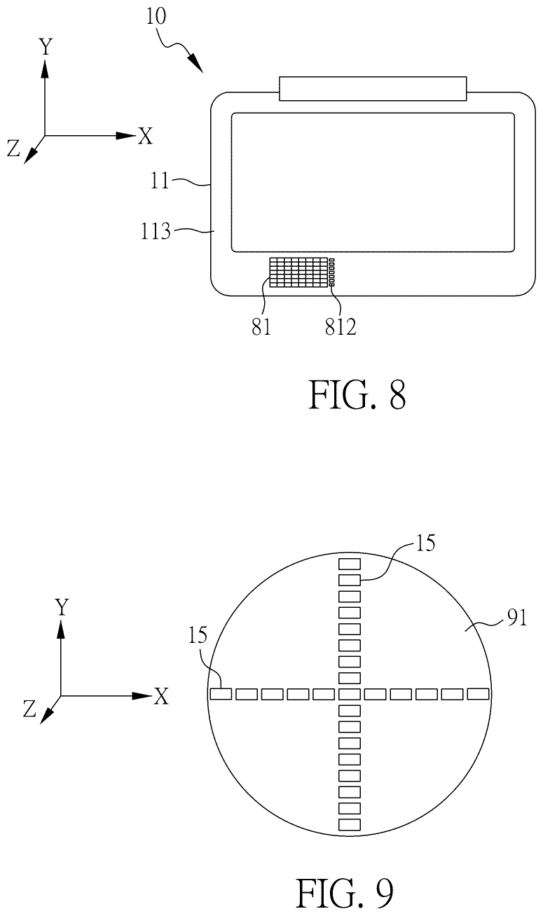

FIG. 7 is another schematic side view of the electronic device, which mainly shows the liquid crystal structure 111 of the dimming structure 11. The liquid crystal structure 111 is formed by stacking a first substrate 701, a first transparent electrode 702, a liquid crystal layer 703, a second transparent electrode 704 and a second substrate 705, and the first transparent electrode 702 and the second transparent electrode 704 are correspondingly divided into a plurality of sub-electrodes 702′, 704′, thereby forming a plurality of sub-areas 111a on the liquid crystal structure 111. The control unit 13 may output at least one voltage to at least one sub-area 111a based on the aforementioned sensing result and the rotation angle (θ) so as to control at least one sub-area 111a to be converted into a dark state to block sunlight.

Moreover, in addition to obtaining the incident angle of sunlight based on the light sensing value, the control unit 13 may also adjust the voltage output to the dimming structure 11 based on the comparison of the sensing value and a sensing threshold, so as to correspondingly control the dark state degree of the dimming structure 11 according to the intensity of sunlight, wherein the sensing threshold may be, for example, a light intensity value. In one embodiment, when the sensing value of the sensor 15 is greater than or equal to the sensing threshold, the incident angle of sunlight corresponding to this result may be used to convert the sub-area into a dark state.

FIG. 8 is a schematic diagram of an electronic device according to another embodiment of the present disclosure, in which a solar panel 81 is disposed on the frame body 113 of the dimming structure 11 to provide the power required for the operation of the electronic device 10. At the same time, part of the solar panel 81 is cut into a plurality of solar cells 812 to serve as sensors. With such a structure, the current values generated by the solar cells 812 may be equivalent to the light sensing values of the light sensors, and the dimming structure 11 may be controlled according to the calculations the same as those of the embodiment using the light sensors, so as to achieve the same sunshade effect.

FIG. 9 is a schematic diagram illustrating the arrangement of sensors of the electronic device according to still another embodiment of the present disclosure. As shown in the FIG. 9, the plurality of sensors 15 of the electronic device 10 of this embodiment are arranged in a cross shape and are disposed on a spherical base 91. With the arrangement structure of the sensors, in addition to detecting the incident angle of sunlight, the electronic device of the present disclosure may be expanded to detect the position of the sun, thereby increasing the accuracy of sunshade.

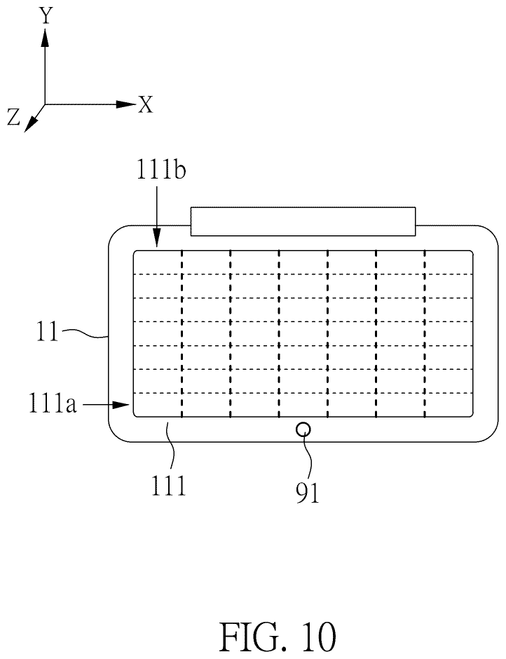

FIG. 10 is a schematic diagram of an electronic device according to still another embodiment of the present disclosure, and please refer to the embodiment shown in FIG. 1 as well. As shown in FIG. 10, in the dimming structure 11 of this embodiment, in addition to In addition to the sub-areas 111a in the X direction (horizontal direction), the liquid crystal structure 111 of the dimming structure is also divided into a plurality of sub-areas 111b in the Y-direction (vertical direction) that are respectively electrically connected to the control unit 13, and the dimming structure 11 is provided with the spherical base 91 as shown in FIG. 9. Through the sensing results of the sensors 15 arranged in a cross shape on the spherical base 91, it is able to further control the corresponding sub-areas 111a and 111b in the horizontal direction and vertical direction to be converted into a dark state so as to improve the accuracy of the sunshade effect.

Features of various embodiments of the present disclosure may be mixed and matched as long as they do not violate the spirit of the present disclosure or conflict with each other.

The aforementioned specific embodiments should be construed as merely illustrative, and not limiting the rest of the present disclosure in any way.

1. An electronic device, comprising:
a dimming structure;
a control unit electrically connected to the dimming structure;
a plurality of sensors electrically connected to the control unit to output a sensing result based on sensing values sensed by the plurality of sensors; and
an angle sensor electrically connected to the control unit to sense a rotation angle of the dimming structure,
wherein the control unit outputs a voltage to the dimming structure based on the sensing result and the rotation angle.

2. The electronic device as claimed in claim 1, wherein the plurality of sensors are light sensors, and the sensing values are light sensing values.

3. The electronic device as claimed in claim 2, wherein two of the sensors arranged adjacent to each other are separated by a central angle.

4. The electronic device as claimed in claim 2, further comprising a lens disposed corresponding to the plurality of sensors.

5. The electronic device as claimed in claim 2, wherein the dimming structure includes a liquid crystal structure and a frame body surrounding the liquid crystal structure.

6. The electronic device as claimed in claim 5, wherein the plurality of sensors are disposed on the frame body.

7. The electronic device as claimed in claim 5, wherein the liquid crystal structure includes a plurality of sub-areas respectively electrically connected to the control unit, and the control unit outputs at least one voltage to at least one sub-area based on the sensing result and the rotation angle.

8. The electronic device as claimed in claim 5, wherein the control unit further adjusts the voltage output based on a comparison of the sensing value and a sensing threshold.

9. The electronic device as claimed in claim 1, wherein the plurality of sensors are solar cells, and the sensing values are current values of the solar cells.

10. The electronic device as claimed in claim 1, further comprising a detector for detecting a distance between eyes of a driver or passenger and a car roof, and the control unit outputs a voltage to the dimming structure based on the distance, the sensing result and the rotation angle.

11. The electronic device as claimed in claim 1, wherein the dimming structure is rotatably installed to a car through a rotating shaft structure.

12. The electronic device as claimed in claim 1, wherein the angle sensor is electrically connected to the rotating shaft structure to receive a rotation signal of the rotating shaft structure so as to determine the rotation angle of the dimming structure.

13. The electronic device as claimed in claim 6, wherein the plurality of sensors are arranged on a substrate of the frame body, and the substrate has an arc surface arranged thereon the plurality of sensors.

14. The electronic device as claimed in claim 6, wherein the plurality of sensors are arranged on a substrate of the frame, the substrate has a plane arranged linearly thereon the plurality of sensors, and a lens is arranged on the plurality of sensors.

15. The electronic device as claimed in claim 10, wherein the detector further detects a distance from the driver or passenger to the dimming structure, and the control unit outputs a voltage to the dimming structure based on the distances, the sensing result and the rotation angle.

16. The electronic device as claimed in claim 7, wherein the liquid crystal structure is formed by stacking a first substrate, a first transparent electrode, a liquid crystal layer, a second transparent electrode and a second substrate, and the first transparent electrode and the second transparent electrode are correspondingly divided into a plurality of sub-electrodes to form the plurality of sub-areas.

17. The electronic device as claimed in claim 9, wherein a solar panel is further provided on the dimming structure to provide power required for operation of the electronic device, and part of the solar panel is cut into the plurality of solar cells.

18. The electronic device as claimed in claim 5, wherein the plurality of sensors are arranged in a cross shape and are disposed on a spherical base.

19. The electronic device as claimed in claim 18, wherein, in a horizontal direction, the liquid crystal structure is divided in a horizontal direction into a plurality of first sub-areas respectively electrically connected to the control unit, and the liquid crystal structure is divided in a vertical direction into a plurality of second sub-areas respectively electrically connected to the control unit.

20. The electronic device as claimed in claim 19, wherein the plurality of first sub-areas and the plurality of second sub-areas are respectively controlled based on a sensing result of the plurality of sensors arranged in a cross shape on the spherical base.
